(19) United States
(12) Patent Application Publication
(10) Pub. No.: US 2012/0001483 A1
(43) Pub. Date: Jan. 5, 2012

(54) SYSTEM AND METHOD FOR CONTROLLING AN ENERGY STORAGE PACK

(76) Inventor: Thomas Bergefjord, Uppsala (SE)

(21) Appl. No.: 13/257,102

(22) PCT Filed: Mar. 18, 2010
(86) PCT No.: PCT/SE2010/050303

§ 371 Date: Sep. 16, 2011

(30) Foreign Application Priority Data
Mar. 18, 2009 (SE) 0950168.5

(51) Int. Cl. H02J 1/00; B60L 1/00

(52) U.S. Cl. 307/9.1; 307/48

(57) ABSTRACT

The present invention relates to a method, a control system (13) and a control device (15) for controlling a storage pack (7), and a vehicle (1) comprising the control system. The invention also relates to a feeding device (17), a storage cell (9) provided with a feeding device and a supply module.

### TECHNICAL FIELD

The present invention relates to a control system for controlling an energy storage pack, such as a battery pack. The invention also relates to a feeding device, a subgroup of storage cells provided with a feeding device, a supply module, a control device, a method for controlling a storage pack, and an electric vehicle or vessel.

### PRIOR ART

In many technical applications there is need to power electrical equipment or machinery with electrical energy at a time or location in which no external power sources, such as a power grid, are available. It is then desired to store electric energy in a movable or portable device, or within the equipment itself, in order to supply the appropriate power. One known method for providing energy is to store energy in storage cells adapted to store energy and to supply the energy as electric energy, such as capacitors, inductors or battery cells. In some applications, such as for electric vehicles or vessels in which the electric energy is used for propulsion, it is desired to store very large amounts of energy, wherein a plurality of such cells may be interconnected to jointly form a storage pack. For example, a plurality of battery cells may be connected in series, in order to supply a higher voltage, in parallel, in order to sustain a larger current, or in any combination thereof.

One problem with arranging many cells into a collective storage pack is that storage cells of different types, qualities or charge levels may affect each other negatively. In particular, small manufacturing differences between battery cells may be sufficient to impair the functioning of the pack. When manufacturing a storage pack extensive testing and grouping of battery cells with similar characteristics must therefore be performed. Another problem is that if one battery cell becomes depleted or nearly depleted while the other battery cells remain charged it is necessary to shut down the pack in advance in order to prevent the depleted storage cell from being damaged. Similarly, during a recharge of the pack, if one storage cell becomes fully charged before the other storage cells the recharge must be terminated or the fully charged storage cell may be damaged. One known method for addressing this problem is to shunt off some or all of the recharge current to the more fully charged storage cells and to dissipate the energy in a resistive element. This, however, leads to large power losses.

In patent document U.S. Pat. No. 6,771,045 a power shuffling system is shown comprising power shufflers arranged in between each pair of neighbouring battery packs in a collection of interconnected battery packs. Hence power may be shuffled between two neighbouring packs, so that their charge levels may be balanced. However, if one highly charged pack is located several battery packs away from a lowly charged pack the power needs to be shuffled through each intermediate battery pack and each power shuffler in between, leading to very high power losses.

In patent document US 2005/0077879 a balancing system is shown comprising energy transfer units, each comprising an inductor, a diode and a switch. Each energy transfer unit is arranged to withdraw a fixed amount of power from one fixed battery cell, and to transfer the power to another fixed set of battery cells with a fixed charge proportion. Hence, for each new combination of sets of batteries to be supplied a new energy transfer unit is needed. This quickly leads to a very large number of energy transfer units, on the order of 2n!, where n is the number of batteries, in order to achieve all possible combinations of energy transfers.

### SUMMARY OF THE INVENTION

One objective of the present invention is to indicate a new manner of managing a storage pack allowing an improved functioning and control of the pack.

According to a first aspect of the invention this objective is achieved with a control system according to claim 1.

According to a second aspect of the invention this objective is achieved with a feeding device according to claim 11.

According to a third aspect of the invention this objective is achieved with a storage cell according to claim 19.

According to a fourth aspect of the invention this objective is achieved with a supply module according to claim 20.

According to a fifth aspect of the invention this objective is also achieved with a control device according to claim 27.

According to a sixth aspect of the invention this objective is also achieved with a method for controlling a storage pack according to claim 33.

According to a seventh aspect of the invention this objective is also achieved with an electric vehicle according to claim 39.

One concept of the aspects above comprises providing a control system for controlling a storage pack comprising a plurality of storage cells adapted to store energy and to supply the energy as electric energy, which control system comprises a plurality of feeding devices, each feeding device being adapted to be electrically connected with a subgroup of storage cells in the storage pack, and at least one supply module arranged to electrically interconnect the feeding devices, wherein each of at least a majority of the feeding devices is adapted to handle an exchange of energy between the subgroup of cells to which it is connected and the supply module. Hence, the energy state and/or charge level of each subgroup of storage cells may be accurately, individually and independently controlled and manipulated.

According to one embodiment each of at least a majority of the plurality of feeding devices is adapted to handle a withdrawal of energy in the form of a voltage and current from its subgroup of storage cells, and to forward the withdrawn voltage and current to the supply module. Thus the charge levels of each subgroup connected with such a feeding device may be individually reduced.

According to another embodiment each of at least a majority of the plurality of feeding devices is adapted to handle a feeding of a feeding voltage in a separate voltage and/current branch to its subgroup of storage cells with power from the supply module. Thus the charge level of each subgroup connected with such a feeding device may be individually replenished.

Preferably, each of at least a majority of the feeding devices is arranged to handle a bidirectional exchange of energy between the subgroup of storage cells and the supply module, wherein the exchange of energy may comprise either of feeding charge to a subgroup with energy from the supply module or withdrawing charge from a subgroup and forwarding energy to the supply module, depending on the present need. Hence each of at least a majority of the feeding devices is able to both feed and to withdraw energy in the form of a voltage and current in a separate voltage/current branch to and from its subgroup of storage cells. Hence the energy or charge levels of each subgroup of storage cells may be easily and individually controlled. One advantage with this control system is that since each subgroup may be both refilled and drained of charge a balancing operation becomes much faster than for other systems, since strong subgroups may be emptied while the weak subgroups simultaneously are refilled. Preferably, each of at least a majority, preferably all, of the feeding devices are also arranged to avoid exchanging any energy in case no transfer of energy is deemed necessary for that subgroup.

According to one embodiment the supply module is adapted to electrically interconnect at least two, preferably at least a majority, and most preferably nearly all, of the plurality of feeding devices with each other. Preferably, the supply module is further arranged to allow a transfer of electrical power within the supply module and in between the feeding devices connected to the supply module. Preferably, the electrically interconnected feeding devices are also adapted to allow a bidirectional exchange of energy between the supply module and the subgroups of cells. The supply module is thus adapted to allow a transfer of energy, and/or to carry charge, from any one feeding device to any of the other feeding devices connected with the same supply module, and hence, energy (and thus charge) may be transferred from any one subgroup of storage cells to any other of the subgroups of storage cells within the storage pack. Thus a storage pack may be accurately and swiftly balanced in respect of the charge levels of the subgroups of storage cells in the storage pack by highly charged subgroups of cells providing energy to the lower charged subgroups of cells, wherein the functioning of the storage pack is improved.

When transferring energy through an electronic component, such as a feeding device, a power loss is incurred. One advantage of the present invention is that by providing the supply module interconnecting the plurality of feeding devices, in the best case, the energy needs only to pass through two feeding devices regardless of the distance, or the number of subgroups of cells, that electrically separates two subgroups involved in a mutual energy transfer. Hence, transfer of energy over large distances with a minimum of wiring and power losses is achieved. Another advantage is that the number of components, and thus the cost of the control system, may be substantially decreased since only one feeding device is needed for each subgroup, while the control system still allows practically all possible combinations of energy transfer.

The supply module is preferably electrically connected with the feeding devices and is arranged to allow a bidirectional exchange of energy to and from the feeding devices. Preferably the supply module is also arranged to carry energy by itself, so that energy received from a subgroup need not necessarily be immediately forwarded to another subgroup, allowing for a more independent control of the subgroups. In one embodiment the supply module may be electrically connected with the storage pack as a whole, or a part of the storage pack, for receiving a joint voltage and current from the storage pack in order to allow feeding of the feeding devices. In reverse, the supply module may also be arranged to feed a joint recharge current from the supply module to the storage pack as a whole, or to a part of the storage pack. In another embodiment the supply module may also be connected or be connectable with an external power supply, such as a power grid or recharging station for receiving power. The supply module thus allows for an efficient manner of providing a voltage to each feeding device with little wiring.

Each of at least a majority of the plurality of feeding devices is preferably connected with a separate subgroup of storage cells, and forms a separate voltage/current branch to that subgroup. Preferably, each feeding device is thus individually and separately connected with its own subgroup of storage cells, and is preferably connected to only one subgroup of cells each. Hence each feeding device may handle an exchange of energy between an individual subgroup of cells and the supply module. However, a feeding device may be connected with two or more subgroups, and is then preferably connected with corresponding two or more separate current branches to the subgroups, so as to allow individual and independent exchange of energy for each subgroup. The feeding device is adapted to be electrically connected between its subgroup of cells and the supply module, in order to handle the exchange of energy there between. Preferably the feeding device is electrically connected between a positive and a negative pole of the subgroup of storage cells, wherein the feeding device may feed or withdraw current to or from the subgroup for supplying or removing energy. The feeding device may comprise logic circuitry, such as a microprocessor or microcontroller for receiving information and/or control signals. Preferably, each feeding device is a separate device, but a plurality of feeding devices may also be provided as one unit, such as on a common circuit board or chip. Additionally, there may be several sets of pluralities of feeding devices.

According to one embodiment the feeding devices are also arranged to monitor the state of each subgroup of storage cells. Preferably the feeding devices are arranged to monitor the state of charge for each subgroup, but the feeding devices may also be arranged to monitor other state variables, such as temperature, expected and present life time, type or fabrication of the storage cells, maximum or minimum voltage, maximum capacity of the subgroup, and others.

The control system may comprise a control device for controlling the feeding devices and the handling of the exchange of energy. The control device preferably comprises logical circuitry, such as a computer, a microprocessor or a microcontroller, for controlling the feeding devices and the exchange of energy. The control device preferably comprises circuitry for receiving sensor signals and emitting control signals. The control device may be located separate from the feeding devices, or may be located within one or more of the feeding devices, and/or may be entirely or partially incorporated with other control systems, such as systems for controlling a load. The control device may also be arranged for monitoring and/or controlling the operation of the supply module. The control system and the control device may be contained within a single unit connectable with the storage cells or pack, or may be divided into several separate units located at different locations. The separated units may then be connected by use of electric conductors and may also communicate by transmitting and receiving electromagnetic or sound waves as control and/or communication signals. The actual positions of the circuitry and logic for controlling the operation of the control system may be located entirely or in parts within a central control device, and/or may be distributed among the feeding devices.

A storage pack may comprise any form of storage cells capable of storing energy and supplying the energy as electric energy. Examples include battery cells, capacitors, and inductors, but other types may also be used. The storage pack is preferably arranged to power a load with electric energy, wherein the load may be used in remote locations lacking a power grid. Preferably the storage pack is portable or moveable, and may be provided within or in connection with electrical equipment or a piece of machinery, which may or may not be responsible for housing and/or moving the storage pack. A subgroup of storage cells may comprise one or more storage cells depending on their size, capacity and the technical application. The storage cells in a subgroup are preferably electrically interconnected, preferably also mechanically connected with each other, in the case the subgroup comprises more than one storage cell. Preferably the subgroups provided in the storage pack are also electrically and preferably also mechanically connected with each other in order to form the storage pack.

Preferably the largest individually controllable subgroup of the storage cells comprises half or less of the cells in the pack. According to one embodiment of the invention the largest individually controllable subgroup of the storage cells comprises ten percent or less of the cells in the pack. According to one embodiment of the invention the subgroup of storage cells comprises ten or less cells. Preferably the largest subgroup of storage cells comprises five or less cells. More preferably the largest subgroup of storage cells comprises three or less cells. Most preferably the largest sub-group of storage cells comprises one single storage cell, wherein each storage cell in the pack may be controlled individually. Preferably at least a majority of the storage cells in the storage pack are members of a subgroup.

Depending on size and application the storage pack may be provided as one unit or divided into several units, both in a mechanical and/or in an electrical sense. This may be the case if the storage pack is provided at several locations within a piece of machinery. The control system may similarly comprise one or more separate supply modules, and one or more separate sets of feeding devices, wherein each supply module is adapted to be connected with its own separate set of the feeding devices. Preferably, the number of separate supply modules and associated pluralities of feeding devices match each other, and are connected with a matching number of separate storage pack units. The purpose of providing several supply modules and associated feeding devices is to decrease the amount of wiring needed. In one embodiment two or more supply modules may be electrically connected with each other through a controllable hub adapted to handle any exchange of energy between the supply modules if needed. Preferably, however, the control system comprises only one supply module interconnecting in principle every feeding device provided within the control system.

The vehicle or vessel preferably comprises a load powered by the storage pack in the form of an electrical motor arranged to provide propulsion for the vehicle or vessel. The propulsion of the vehicle or vessel is hence powered by the storage pack. Preferably the vehicle is a land based vehicle, preferably a road-bound vehicle. The vessel is in turn preferably a water-based vessel. The invention could also be useful for aircrafts. Other applications for the present invention includes storage packs for powering electrical tools, electrical heating, electric machinery or any other application in which a load is powered by a storage pack.

According to one embodiment the control system comprises a control device arranged to individually control each of at least a majority of the feeding devices to perform the exchange of energy independently. Preferably each of at least a majority of the feeding devices is correspondingly independently controllable. Preferably, each of at least a majority of the feeding devices is arranged to handle the exchange of energy between the supply module and its individual subgroup of cells independently from the other feeding devices. Hence the handling of the exchange of energy, such as charging and discharging, is independently controlled for each individual subgroup of storage cells. Thus the control system may control and change the state of charge for only those subgroups of storage cells with deviating charge levels. Hence there is no need to affect a subgroup or cell with non-deviating charge levels in order to correct the charge level of the deviating subgroup or cell.

This is particularly valid in case the supply module may withdraw or supply a joint current from the entire storage pack or from an external source, wherein there is no need to match any power exchange for one subgroup with a corresponding power exchange in another subgroup. Additionally, the versatility of the control system is increased so that the control system may address a wider range of problems with the storage pack and/or achieve further advantages as described below. Also, the power losses may be reduced, since power may be exchanged locally and independently in each feeding device. Yet another advantage is that the speed of changing the state of and of controlling the storage pack is improved since a subgroup may be controlled directly without the need to operate any other subgroups.

According to one embodiment the control system is arranged to recharge and/or to balance the storage pack. Preferably, the control system is arranged to order a feeding device connected with a subgroup of storage cells with lower than average charge level to independently and individually feed a voltage and/or current to that subgroup of storage cells. The feeding device thus takes power from the supply module, possibly in the form of a common feeding voltage supplied by the supply module, and then supplies an individual feeding voltage to the subgroup of storage cells. By recharging the subgroups of storage cells individually and independently each subgroup may be charged with its optimum charging current, leading to a faster recharge. By balancing the subgroups in a storage pack to have an equal charge level the performance of the storage pack is improved.

According to one embodiment the control device is arranged to receive information on the present charge levels of the subgroups of storage cells, and to control at least one feeding device connected with a subgroup with higher charge level than an average charge level of the storage pack to transfer energy from that subgroup to the supply module. Preferably, the control system is thus arranged to order a feeding device connected with a storage cell with higher than average charge level to independently and individually withdraw a voltage and/or current from that storage cell, and to transfer this power to the supply module by supplying a voltage aiding in sustaining the common feeding voltage. Hence, it is possible to decrease the charge of one subgroup of storage cells, leading to a faster balancing. Also the withdrawn power may be directly transferred and supplied to another, lower charged subgroup through the supply module.

According to one embodiment the control device is arranged to control the at least one feeding device connected with a subgroup with higher charge level than an average charge level of the storage pack to transfer energy from the subgroup to the supply module during a recharge of the storage pack with a joint recharge voltage. Charging a storage pack with a joint recharge voltage and current applied over all storage cells in the storage pack simultaneously simplifies supplying a high charge current. Such joint recharging is therefore normally faster than individual charging, as long as it is possible to uphold the magnitude of the charge current. However, when one subgroup of storage cells, or one storage cell, begins to reach its maximum charge capacity, the joint charging current must be either terminated or decreased. By withdrawing power from such a highly charged subgroup or storage cell its charge will decrease, or at least increase at a lower rate, so that the joint recharge may be carried out for a longer time or at least with a higher current. Hence a faster overall recharge of the storage pack is achieved. Preferably, the power withdrawn from the highly charged subgroup may simultaneously be supplied to a lowly charged subgroup via the supply module, simultaneously with the joint charging, even further speeding up the recharge process. In another embodiment the power thus withdrawn from the high charged subgroup or cell may instead be added to the joint recharge current.

In one embodiment the control system may be operated while using the storage pack for supplying a voltage and current to a load. Thus, a feeding device may handle an exchange of energy between a subgroup or cell and the supply module by feeding or withdrawing a voltage and current from a subgroup of storage cells while the same subgroup supplies a voltage to the load. Hence the subgroup of cells in the storage pack may be individually and/or independently controlled while using the storage pack for supplying energy. The exchange of energy between the subgroup and the supply module will also affect the voltage and current withdrawn from the pack during actual use, making it possible to control the function of the storage pack during use of the pack for providing electric energy. The control system could then be used to support a weakly charged subgroup of storage cells during operation, wherein a larger joint output current from the storage pack as a whole can be sustained for a longer time even if one subgroup or cell begins to be depleted. Furthermore, in case the feeding device is sufficiently strong, balancing may actively be performed throughout the operation of the storage pack, so that the need for downtime periods is reduced. Due to the possibility of transferring energy via the supply module a stronger storage cell may also support a weaker storage cell during operation of the storage pack, wherein a greater power may be withdrawn from the storage pack during operation. For prior art balancing in which the systems are only able to balance the storage pack while it is inoperative, the stronger cells would irrevocably place a higher toll on the weaker batteries, regardless of any previous balancing, since the stronger subgroups would still cause a higher current which the weaker subgroups are unable, or at least less able, to cope with.

In order not to overload the feeding devices too much, it is preferable to handle the exchange of energy between the subgroup and the supply module under operating conditions with less power withdrawal from the storage pack. Preferably, an exchange of energy is performed while supplying electric power from the storage pack, which is less than or equal to 50% of the maximum power available from the storage pack. Preferably, an exchange of energy is performed while supplying electric power from the storage pack, which is less than or equal to 25% of the maximum power available from the storage pack. In one embodiment an exchange of energy is performed while no power is supplied by the storage pack. Periods of lower or no power supply may occur while using the load, for example, in the case of a vehicle and a load in the form of an electric motor, such periods may occur when waiting for a green light, or driving down a slope. The selections of such periods for handling an exchange of energy will of course depend on application and on the design of the control system and feeding devices.

A further advantage with the present control system and method is that due to the independent and individual control of each feeding device and due to the supply module interconnecting the feeding devices, the control system may be used with a scalable storage pack, wherein a new subgroup or cell may easily be added to the storage pack by extending the number of feeding devices. An old subgroup or cell may also easily be removed or replaced. Hence, in case a subgroup or cell is broken it can easily be replaced without the need to replace the entire storage pack. Furthermore, storage cells having better performance due to developments in storage cell technology may be included in a storage pack containing cells made with earlier technology. Yet another advantage is that the need for matching individual battery cells with each other before being assembled into the same storage pack is reduced. With the system it is sufficient that the storage cells within the same subgroup of storage cells are matched, while the subgroups per se need only be fairly matched with each other. Since the matching procedure is a very time consuming step when manufacturing prior art storage packs the cost of producing the storage pack intended for use with the present control system may be substantially reduced.

According to one embodiment the supply module comprises a first and second power line electrically interconnecting the plurality of feeding devices. The first and second power lines are preferably connected with a low potential and a high potential connection of each of the feeding devices. Preferably the feeding devices are interconnected in parallel between the power lines. Preferably the same two power lines are connected with at least a majority, preferably at least 85%, and most preferably all, of the feeding devices, wherein the total length of power lines, or wiring, for supplying the feeding devices with power, is significantly decreased. Furthermore, the two power lines, common to the feeding devices, also ensure a low resistance and an equal electrical connection to all feeding devices. Also, the two power lines admit an efficient transfer of power from any one feeding device to any other feeding device connected to the same power lines. Preferably, the two power lines are designed to carry a voltage difference between them in order to feed a common feeding voltage to the feeding devices.

According to one embodiment the supply module comprises a capacitor connected between the power lines. The capacitor is arranged to act as a temporary energy storage or buffer within the supply module. Hence, in case the feeding devices on the average provides a positive amount of power to the supply module the surplus power may be stored on the capacitor, and correspondingly, in case the feeding devices on the average draws power from the supply module, previously stored power may be supplied by the capacitor. Furthermore, the capacitor may protect the supply module from temporary voltage and/or current peaks.

According to one embodiment the supply module comprises a voltage controller arranged to strive to keep the common feeding voltage at a target voltage. Hence the control of the individual feeding devices is simplified since the common feeding voltage is known. Preferably, the target voltage is a constant voltage, wherein the supply module provides a direct current. Hence the number of information bits in a communication protocol may be reduced since the target voltage is known. According to one embodiment the voltage controller comprises a converter connected with and arranged to feed a constant voltage to the supply module. The voltage controller may be connected and/or connectable with an external power source, such as the power grid, in order to receive power. Alternatively, the voltage controller may be connected or be connectable with the storage pack and arranged to receive the joint output voltage and current from the storage pack. Naturally, the voltage controller may also be used to feed power from the supply module to the external grid and/or to the joint storage pack as a whole. Preferably, the operation of the voltage controller is controlled by the control device.

According to one embodiment at least a majority of the feeding devices each comprises a converter comprising a first input/output terminal having two contacts adapted to be connected with a negative and a positive pole, respectively, of the subgroup of storage cells. Preferably, the converter further comprises a second input/output terminal having two contacts adapted to be connected with the first and second power lines, respectively, of the supply module. The converter is thus electrically connected in between the subgroup of storage cells and the supply module. Preferably, the converter is arranged to handle the transfer of energy between the supply module and the subgroup of storage cells. Preferably, the converter is bidirectional, wherein both the first and second terminals may receive and/or output a voltage. Hence the converter is arranged to admit an exchange of power in both directions. Thus only one component is needed for allowing the bidirectional exchange of power. The converter is thus arranged to convert the common feeding voltage into a separate feeding voltage for the subgroup of cells and vice versa.

The feeding device comprising a converter may receive a common feeding voltage of one magnitude, and convert it into a feeding voltage with another magnitude for feeding to the subgroup of storage cells. Preferably the converter is arranged to output a voltage in the range from the lowest voltage supplied by a cell before it is depleted, to the highest voltage with which the cell may be recharged without being damaged. Preferably, the voltage fed to the storage cell may vary between 3.0-4.5 V. The converter is thus able to handle different potentials and/or input and output voltages. Preferably the converter is arranged to both receive and/or output different voltage magnitudes, wherein the versatility of the feeding device is improved. Another advantage with a converter is that it allows individual and independent feeding of a subgroup and that a converter is inexpensive, both in purchase and in operation. According to one embodiment the converter is a DC/DC-converter. Such a converter is easily controlled, and may also be switched off in order to avoid feeding or receiving any voltage or current, and the exchange of power. Preferably the supply module is then arranged to supply a common feeding voltage in the form of a DC current and voltage to the feeding device.

According to one embodiment of the invention the power for recharging the storage pack and/or individual subgroups of storage cells is received from an external power supply. The external power supply may be the local power grid, or some other source of electricity. According to one embodiment the method according to the invention comprises sensing the voltage and current level of the external power supply, and adapting a receiving module to receive the present voltage and current level and convert it into a voltage level useful for the control system. The receiving module is preferably adapted to receive at least two different voltage and current levels. Thus the same receiving module may receive different types of electric power, so that the vehicle may be used in different countries or locations having different standards of power or different types of power supplies.

According to one embodiment an exchange of energy between a subgroup and the supply module is performed, which exchange is adapted to compensate for a voltage difference between the subgroup relative to a least one other subgroup. Preferably, the exchange of energy is adapted to compensate for the difference, so that the voltages and currents supplied by the two subgroups are perceived as being substantially equal, and at least not differing by more than 10%. Thus, storage cells of different types and/or having different voltages due to manufacturing variations may be arranged within the same storage pack, since the differences may be compensated for by the applied voltage. This in turn leads to that the manufacturing of a pack is simplified, since it is no longer necessary to perform testing and grouping of storage cells. Furthermore, the use of a smaller number of larger cells is simplified.

According to one embodiment of the invention the storage pack is used for supplying electric energy to the load in order to operate the load in a first, active state, after which the load is operated in a second, regenerative state of the load, in which the load converts built-up energy in the load into a regenerated voltage and current, and at least a part of the regenerated voltage and current is fed as a voltage and current in the separate voltage/current branch to at least one sub-group of storage cells. Hence the subgroup is recharged by the regenerated power. Preferably, energy from the storage pack is withdrawn as a joint, storage pack current supplied to an electric motor for conversion into kinetic energy for driving the motor in a first, drive state, and the electric motor is then operated in a second, generator state, wherein the electric motor converts built-up kinetic energy into a regenerated voltage and current. The, or parts of the, regenerated voltage and current is then separately fed to at least one sub-group of storage cells. According to one embodiment of the invention the regenerated voltage and current is directed to one or more subgroups monitored as having the lowest energy levels in the storage pack. Hence the regenerated voltage may be used for balancing the cells in the pack, which in turn means that the pack may be used more effectively.

According to another embodiment of the invention the regenerated voltage is directed to a second load in the appliance driven by the storage pack. Since the efficiency of the recharge process is lower than 100%, at least some of the energy is lost during the recharge. Hence it is more efficient to use the regenerated voltage to drive a second load, if it exists, rather than to first store only a part of the regenerated energy and then drive the second load with the stored part. A second load may be an auxiliary system, such as a climate system in the case that the appliance is a vehicle. This is particularly useful in cold weather, since an electric motor generally does not generate sufficient waste heat for warming a passenger compartment, but energy for heating must normally be taken from the storage pack.

### BRIEF DESCRIPTION OF THE ATTACHED DRAWINGS

The invention is now to be described as a number of non-limiting examples of the invention with reference to the attached drawings.

FIG. 1 shows a vehicle comprising a control system for controlling a storage pack comprising a plurality of electric energy storage cells according to one example of the invention.

FIG. 2 shows a storage cell provided with a controller device according to one example of the invention.

FIG. 3 shows one example of a method according to the invention.

### DETAILED DESCRIPTION

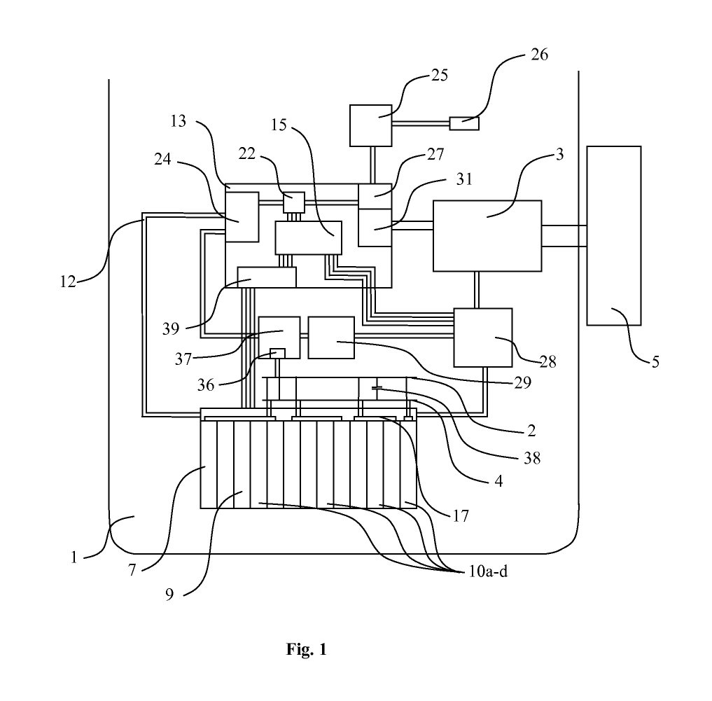

FIG. 1 shows an electric vehicle 1 comprising a load in the form of an electric motor 3 for driving the rotation of a driving wheel 5 for propelling the vehicle. The electric vehicle 1 is provided with a storage pack 7 comprising a plurality of storage cells 9 adapted to store energy and to supply the stored energy as an electric voltage and current. In this example the storage cells are connected in series in order to supply a joint, storage pack voltage and current with a high voltage. In this example the storage cells 9 are rechargeable galvanic battery cells, in this example Lithium-iron Phosphate cells, having a maximum output voltage of 3.7 V.

The vehicle 1 further comprises a control system 13 for controlling the storage pack 7. The control system comprises a plurality of feeding devices 17, wherein each feeding device 17 is connected with one subgroup 10a-d of storage cells. In this example each subgroup comprises five, three, two and one storage cells respectively. In another example however, a subgroup may contain up to twenty storage cells, in another example up to ten storage cells, and in yet another example up to ten percent of the storage cells in the pack. In this case the feeding device is connected between the poles furthest apart within each subgroup, in an electrical sense.

The control system 13 further comprises a supply module 37 arranged to electrically interconnect the plurality of feeding devices 17 with each other. Each feeding device 17 is further adapted to handle an exchange of energy between its subgroup 10a-d of storage cells and the supply module 37. By the feeding devices transferring energy between the supply module 37 and its subgroup of storage cells the charge level of each individual subgroup 10a-d of storage cells 9 may be individually controlled and manipulated. Hence, a balancing of the charge levels of the subgroups of storage cells may easily be achieved.

The control system 13 further comprises a control device 15 adapted to control the plurality of feeding devices 17 and the handling of the exchange of energy. The control device 15 is arranged to receive feed-back signals from the plurality of feeding devices concerning their performance, and state signals concerning the state of the subgroup of storage cells. The control device 15 is further arranged to issue control signals to the plurality of feeding devices for controlling the exchange in response to the feed-back and state signals. The feeding devices in turn are arranged to receive and to handle the exchange of energy based on the control signals from the control device.

The feeding device 17 is adapted to handle the exchange of energy by being arranged to withdraw energy in the form of a voltage and current from the subgroup of storage cells, and to transfer the withdrawn energy to the supply module. Hence the charge level of each subgroup of storage cells may be reduced. Each feeding device 17 is also adapted to handle the exchange of energy by feeding a voltage and current to the subgroup of at least one storage cell, wherein the feeding device transfers energy from the supply module 37 to its subgroup 10a-d. Hence the charge level of each subgroup of storage cells may be refilled. In this example the feeding devices are arranged to feed voltages and currents in separate voltage/current branches to the positive and negative poles of the plurality of sub-groups of the storage cells 9 in the storage pack 7, so that the feeding of one subgroup will not affect another subgroup in the storage pack. In this example each feeding device is arranged to handle a bidirectional exchange of energy between the supply module 37 and the subgroups of storage cells, wherein the feeding device may both withdraw and supply energy to the subgroup of storage cells. Hence each subgroup of storage cells may be both individually recharged or discharged depending on the present need.

The supply module 37 is further arranged to allow a transfer of electrical power within the supply module and in between the plurality of feeding devices 17 connected to the supply module. The supply module 37 is also arranged to upkeep a common feeding voltage within the supply module 37, and to supply the common feeding voltage to the plurality of feeding devices. Thus, energy, and/or charge, may be transferred from any one feeding device to any of the other feeding devices via the supply module 37, and likewise from any one subgroup of storage cells to any other of the subgroups of storage cells within the storage pack. Thus a storage pack may be accurately and swiftly balanced in respect of the charge levels of the subgroups of storage cells by highly charged subgroups of cells providing energy to the lower charged subgroups of cells. With the present control system the energy may be efficiently transferred between different subgroups with deviating charge, regardless of their present locations within the storage pack. Also, the control system remains effective even if the number of or state of the storage cells with deviating charge changes.

The supply module 37 is in this example powered by, and may also feed power to, a number of different sources. As mentioned above the supply module 37 may be powered by receiving energy from individual feeding devices operating to withdraw power from individual subgroups of storage cells and supplying the power to the supply module 37. Primarily, however, the supply module 37 is powered by receiving energy from the storage pack as a whole. The supply module may then receive a part of, or in exceptional cases all of, the output current from the storage pack. The control system 13 thus comprises a pack-to-cell converter 29, adapted to receive electric power from the storage pack, in this example via a load control module 28 (to be described later) and to return part of the joint storage pack current back to the supply module 37, which may then supply the common supply voltage to the plurality of feeding devices 17. Naturally, the converter 29 may also be operated in the other direction so as to feed power from the supply module 37 to the storage pack as a whole. The supply module 37 may also be powered by an external source, such as the power grid, if available. Typically, an external power source is provided when recharging the storage pack. The supply module 37 is then arranged to receive power from a power receiving module 27 adapted to be connected with the external power source, wherein the supply module 37 may feed the feeding devices with a common feeding voltage originating from the external power. The power receiving module 27 may also be operated in the other direction in order to feed power from the supply module to the external power source.

The control system 13, and the control device 15, is adapted to control the feeding devices 17 to handle the exchange of energy for each sub-group of storage cells separately and individually. The control system 13, and the control device 15, is also adapted to control each of the feeding devices 17 to handle the exchange of energy for each sub-group of storage cells independently from the exchange of energy for any of the other storage cells. The feeding devices are also adapted to form a separate voltage/current branch to the positive 19 and the negative pole 21 of the sub-groups. Hence, it is possible to recharge each subgroup individually and independently, without affecting any other subgroup. Furthermore, it is possible to charge a pack comprising battery cells having different characteristics, such as different output voltages.

The control system 13 and/or feeding device 17 are further adapted to feed a voltage and current to a subgroup of storage cells having a lower energy level than an average energy level for the subgroups of storage cells in the storage pack 7, which voltage and current is adapted to drive a recharge of the cells. Hence, cells having low energy levels are recharged, so that the storage pack 7 becomes balanced. The control system 13 and/or feeding device 17 are further adapted to withdraw a current from another subgroup of storage cells having a higher energy level than an average energy level for the storage cells in the storage pack 7. In this example the control system 13 and/or feeding device 17 are adapted to feed a separate voltage and current to a subgroup of storage cells having an energy level lower than 15% of the average energy level, but in another example, any other appropriate difference may be selected depending on application.

The control system 13 further comprises a load control module 28 adapted to control the operation of the load, in this example the electric motor 3, and the power supplied to the load from the storage pack 7. The control system 13 and/or feeding devices 17 are further arranged to handle an exchange of energy between a subgroup and the supply module 37 while the load is being operated. Hence, the control system 13 also indirectly controls the power supply from the storage pack 7 by feeding separate voltages to the individual subgroup of cells while the load is operated. In this example the control system and the feeding devices 17 are adapted to balance the storage pack 7 during the operation of the load. Hence a subgroup with low charge may be supported during actual operation, so that the storage pack may continue to deliver a high current, even if one subgroup begins to have a lower charge than the other subgroups.

In this example the control system and the feeding devices 17 are adapted to balance the storage pack 7 with energy withdrawn from the storage pack 7 as a whole, so that the storage pack is continuously balanced by the control system 13. The control system 13 is arranged to balance the storage pack only when the current needed to be taken from the feeding devices is low, so as not to damage the feeding circuits 23. In this example, the storage pack 7 may be balanced for example during stand stills, during decelerations, when the vehicle enters a downward slope, or when the built-up kinetic energy of the vehicle 1 is sufficient for moving the vehicle. The subgroups controlled while operating the load may also be fed by a voltage originating from the storage pack as a whole, by returning part of the joint output voltage.

The control system 13 and/or feeding devices 17 are further arranged to apply a voltage to a subgroup of storage cells having an output voltage differing from the average output voltage for the subgroups, which applied voltage is adapted so as to compensate for the voltage difference and even out the output voltages between subgroups of cells in the storage pack 7. In this example, the feeding device feeds a separate compensating voltage to cells having a voltage output differing by more than 15% from the average voltage, but any other appropriate difference may be selected depending on the application. A cell having a differing voltage output, for example due to manufacturing variations, may be damaged or may adversely affect the storage pack by driving an unnecessary recharge in neighbouring cells or by itself becoming depleted. By compensating for the voltage difference, it is not necessary to do extensive testing and grouping of cells when manufacturing the storage pack, decreasing the manufacturing costs.

The control system 13 and/or feeding device 17 are further adapted to feed energy to a subgroup of storage cell(s) having such a low energy level that further withdrawal of energy may damage the cell. In this example the control system 13 and/or feeding device 17 are adapted to feed energy to a subgroup having an energy level less than 10% of the energy level of the subgroup as fully charged. The 0% level is here taken to be the level under which the cell may be damaged from being depleted. The feeding device is adapted to prevent further withdrawal of energy from the subgroup, by providing the demanded power from the feeding device instead. In this example the feeding device 17 is arranged to feed a separate voltage and current corresponding to the normal supply voltage and current from that subgroup. Thus, the storage pack 7 may continue to supply electric energy to the load 3, since the low energy subgroup is prevented from supplying any further energy, so that damage is avoided.

Due to the above, it is not necessary to restrict the supply of energy from the storage pack due to the presence of one subgroup with low energy level. Even though some energy is lost due to resistance when using this method, a larger part of the energy stored in the pack will be available for driving the vehicle, since it is not necessary to restrict the energy supply from the pack as early. Estimates show that by using compensation, balancing and prevention of subgroups from supplying energy as described above, about 10% more energy may become available for driving the vehicle, since there is less need for restricting energy withdrawal from the storage pack 7. Hence the range of a vehicle may be increased. Furthermore, the feeding device simultaneously recharges the low energy storage cell(s), wherein the storage cells in the storage pack becomes more balanced and thus the lifetime of the cells may also be improved.

In the event that the vehicle is decelerated, the electric motor 3 is arranged to function as a generator and to convert the built-up kinetic energy, in the form of vehicle speed, into a regenerated voltage and current. The control system 13, in this example the control device 15, comprises a second receiving module 31 adapted to receive the regenerated current from the electric motor 3. The control system 15 is further adapted to control the feeding devices 17 to feed the regenerated current to at least one subgroup of the interconnected storage cells. In this example, the control system 15 controls the feeding devices 17 to feed the regenerated current to subgroups of storage cells 9 having a lower energy level than the average energy level for the subgroups in the storage pack. Hence, the regenerated energy is used for balancing the storage pack 9 while driving the vehicle.

In this example the control system 13 is also adapted to charge at least a majority of the storage cells in the storage pack 7 with a joint, charging current through a joint charging conductor 12, for example when an external power source is provided for recharge of the storage pack. By charging with a joint, charging current it is easier to recharge with a higher power, wherein the charging is faster. The control system 13 is further arranged to reduce the joint charging power, and to subsequently terminate the joint charging power, when the storage cells 9 becomes more and more fully charged, and then to switch to individual charging of the subgroups or cells. The control system 13, and the control device 15, is also arranged to control feeding devices connected with subgroups with charge levels higher than an average charge level to withdraw power from the subgroups and supply to the supply module 37. Hence the joint charging may be continued for a longer time and with a higher charging current, which may decrease the total recharge time. The control system 13, and the control device 15, may then control feeding devices connected with subgroups with lower charge levels than the average charge level to feed the excess energy from the supply module 37 to the lowly charged subgroups, or alternatively, to supply the excess energy to the joint recharge current.

In this example the supply module 37 comprises a first 2 and second 4 power line electrically interconnecting the plurality of feeding devices 17. The first and second power lines are arranged to carry a voltage between them, wherein the first power line 2 has a low potential and the second power line 4 a high potential. The feeding devices 17 are interconnected by being connected in parallel between the two power lines. The supply module 37 and the two power lines thus feed a common feeding voltage to the plurality of feeding devices. A feeding device 17 may withdraw power from the supply module by allowing a current through the feeding device driven by the potential difference between the power lines. A feeding device may also supply power to the supply module by feeding a current with a slightly higher voltage than the voltage between the power lines to the supply module 37. The two power lines ensure a low resistance for a current passing through the supply module, and admit an efficient transfer of power from any one feeding device to any other feeding device connected to the power lines.

The supply module comprises a voltage controller 36 arranged to feed the common feeding voltage to the first 2 and second 4 power lines. The voltage controller may be arranged to withdraw a voltage from an external source or from the storage pack. In this example the voltage controller 36 comprises a converter, wherein the voltage level of the common feeding voltage is controllable. The voltage controller 36 is in this example arranged for striving to keep the common feeding voltage at a target voltage, in this example a constant target voltage of about 80-100 V. The supply module further comprises a capacitor 38 connected between the power lines. The capacitor may store charge temporarily and acts as a buffer within the supply module. Hence, the supply module 37 is protected against damage from temporary current peaks. Due to the capacitor 38 and the voltage controller 36 in the form of a converter, the supply module may also store and/or deliver energy, in case the sum of the energy exchanges of the feeding devices do not add up to zero at a specific instant.

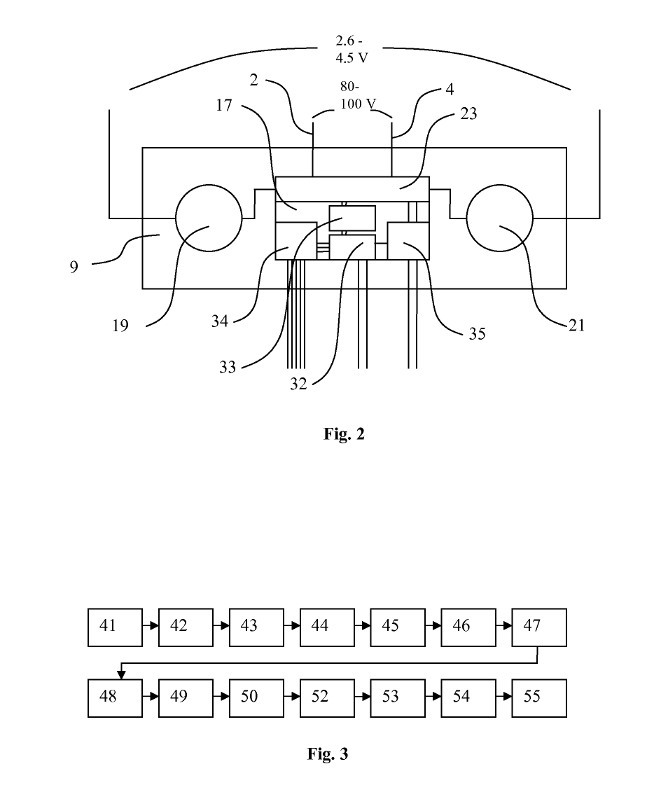

In FIG. 2 one example of a subgroup comprising only one single storage cell 9, and a feeding device 17 connected with the subgroup of one storage cell 9, are shown in closer detail. The feeding device 17 comprises a plurality of electronic circuits and modules provided on a circuit board for performing a number of different functions. Even though only one exemplary configuration is shown a man skilled in the art is able to construct many variations based on the disclosed principles. In particular, the association of functions to the separate modules and circuits can be done differently, and also the number of modules and circuits can be changed without departing from the scope of the invention. Additionally, some of the functions may be allocated to be performed by either of the feeding device 17 or by the control device 15, without departing from the invention. The modules and electronic circuits can be realized in hardware, software or any combination thereof, and may comprise both analogue and digital circuitry.

The storage cell 9 comprises a first, positive pole 19, and a second, negative pole 21, for supplying a voltage and current from the storage cell. The feeding device 17 is formed on a circuit board and is connected between the positive 19 and the negative pole 21 of the subgroup for monitoring and controlling the storage cell. In this, preferred, example the feeding device 17 is positioned physically attached onto the cell 9, but in another example the feeding device may be positioned elsewhere, such as together with or within the control device 15, and be connected with the poles of the subgroups or storage cell via electric conductors.

The feeding device 17 comprises a feeding circuit 23 connected between the positive and a negative poles of the subgroup. In this example the feeding circuit 23 comprises an independently controllable DC/DC-converter, wherein a first input/output terminal is connected between the first and second poles for feeding a feeding voltage to the storage cell and/or for withdrawing a current from the storage cell. The converter 23 further comprises a second input/output terminal connected to the first 2 and second 4 power lines of the supply module 37 for feeding or receiving the common feeding voltage. The feeding circuit 23 is thus arranged to handle an exchange of energy between the storage cell and the supply module, by converting the common feeding voltage from the supply module into an appropriate feeding voltage for the storage cell 9, or vice versa.

The feeding device 17 further comprises a monitoring module 33, which is directly connected with the feeding circuit 23. The monitoring module 33 is arranged to issue control signals for controlling the operation of the DC/DC-converter and the handling of an exchange of energy between the storage cell 9 and the supply module. In this example the monitoring module 33 issues control pulses controlling a switching operation within the DC/DC-converter for achieving the conversion. The monitoring module 33 is also arranged to operate the feeding circuit 23 in a measuring state, in which the monitoring module receives measurement signals from the feeding circuit 23 with information on the present voltage level of the storage cell 9. The monitoring module 33 is thus connected with the feeding circuit 23 in order to measure the voltage between the two poles 19, 21. The monitoring module 33 may also be arranged to monitor other conditions or states of the storage cell 9, such as its temperature.

The feeding device 17 comprises a control module 32 comprising control logic for controlling the operation of the feeding device 17. The control module 32 may comprise a microcontroller, or some other form of logic or microprocessor. The control module 32 is connected with and adapted to control the monitoring module 33, and, through the monitoring module 33, also the feeding circuit 23, by issuing a signal to the monitoring module 33 concerning a desired voltage to be applied onto the subgroup by the feeding circuit 23. The feeding circuit 23 is thus arranged to feed the separate voltage to the two poles, or to withdraw energy from the storage pack, based on control signals from the control module 32.

In a measuring state, the feeding control module 32 is adapted to receive the information on voltage level from the monitoring module 33, and to estimate the energy or charge level inside the storage cell 9 based on the received information. In case the cell 9 is a battery having a flat charge-to-voltage curve, the feeding control module 32 may also be arranged to estimate the charge by performing calculations based on the time integral of current withdrawal from the storage cell 9. In this example the feeding control module 32 and the monitoring module 33 are both microcontrollers, but in another example the modules may be part of a software program or be any kind of electronic device.

The feeding device further comprises a communication module 34 arranged to handle any communication between the feeding device 17 and the control device 15. The communication module 34 is in this example a communication bus connected with the control device 15. The control module 32 is arranged to gather information from the monitoring module 33, to process the information from the monitoring module 33 on the state or condition of the subgroup, and to communicate the information to the control device 15 via the communication module 34. In operation the control module 32 may be arranged to communicate part of or all of the information gathered from the monitoring module 33, and information on the present charge level, to the control device 15.

In operation the control module 32 is arranged to acquire data on the present charge level as described above, and to communicate this data to the control device 15. The control device 15 receives the data on charge level from the feeding device and from any other feeding devices within the control system. The control device 15 then calculates an average charge level for the subgroups of storage cells in the storage pack, and communicates the average charge level to the feeding devices. Depending on design either the control device 15, the control module 32, or a combination of the two, is arranged to decide on whether to perform an exchange of energy based on the information on the state, condition and charge level of the present subgroup, on the state and condition of other subgroups within the same storage pack, and, in particular, on the average charge level for all subgroups of storage cells in the storage pack. In case the present charge level is higher than the average charge level with a sufficient threshold, the control module 32 orders the monitoring module to control the feeding circuit to withdraw energy from the subgroup and to supply the energy to the supply module. In case the present charge level of the subgroup is lower than the average charge level with a sufficient threshold, the control module 32 instead orders the monitoring module to control the feeding circuit to feed energy from the supply module to the subgroup.

By controlling the conversion in the feeding circuit 23 different voltages may be fed to the subgroup or cell, depending on the present need. In particular the converter and may be adapted to feed the storage cell 9 with a variable voltage, depending on need and purpose. In this example the feeding devices 17 are arranged to feed the storage cells 9, or receive a voltage from the storage cells, with a voltage level in the range from the lowest voltage supplied by a cell before it is depleted, to the highest voltage with which the cell may be recharged without being damaged. In this example the voltage fed to the storage cell 9 may vary between 3.0-4.5 V.

The control device 15 is arranged to receive the information on the subgroups of cells in the storage pack 7, and to perform necessary calculations and/or comparisons in order to control the feeding devices 17 and thus the storage pack 7 as described above. In particular the control device 15 is arranged to calculate an average charge level for the storage pack, but the control device 15 may also be arranged to estimate the charge levels of each individual subgroup. The control device 15 is further arranged to generate control signals to the plurality of feeding devices 17, which are transferred through a communication bus 39 to the feeding communication module 34 of the individual feeding devices 17. The control signals may be issued to all feeding devices, but may comprise an identity code, so that only the addressed feeding device reacts to the control signal. The control signals may alternatively be issued to each feeding device separately, so that different feeding devices may be given different orders depending on the state and condition of its associated subgroup of storage cells. Hence the control device 15 controls at least a majority of the converters by transmitting control signals to the feeding devices 17.

The feeding device 17 is further arranged to turn off the conversion in the feeding circuit 23 in a passive state of the feeding device 17, wherein the connection between the two poles through the feeding circuit is switched off to avoid a current between the two poles, for example when there is no need for controlling the subgroup or storage cell 9. Thus there is less current leakage when using the storage pack 7 for supplying energy or when the storage pack 7 is at rest.

On a more detailed level, the monitoring module 33 is arranged to monitor at least one state variable of the sub-group of electrical energy storage cells in the electrical energy storage pack to which the monitoring module is connected. In this example the monitoring module 33 monitors conditions and states that may affect the functioning of the storage cell 9, such as temperature, voltage, charge level, present energy level, age, etc. The control module 32 is in turn arranged to provide information such as the type of storage cell, the maximum charge level, maximum charge current, minimum charge level, and number of storage cells in case the feeding device is connected to a subgroup comprising several storage cells. The information may be used internally by the control module 32 for performing calculations, but may also be communicated to the control device 15 through the communication module 34. The energy level in a storage cell 9 may be sensed by sensing the potential difference generated between the positive and negative poles, or may be calculated by monitoring the current withdrawal and current input into the electrical energy storage cell and calculating the energy level based on the information.

In this example the feeding device 17 further comprises an alarm module 35 adapted to generate an alarm signal in the event that the monitoring circuit detects an aberrant condition, an error or a fatal error. The control system 15 is then arranged to immediately shut down the storage pack so as to prevent any further energy withdrawal from the pack. In this example the control system 15 is also arranged to disconnect the subgroups of storage cells from each other, wherein the highest voltage is decreased from the combined voltage of the serially connected cells to a lower voltage of a subgroup of cells, or of a single cell.

In this example the vehicle 1 comprises a power connection 25 adapted to be connected with an external power supply 26. The power connection 25 is further connected with a power receiving module 27 comprising a variable converter adapted to convert the received power into a form useful for the control system 13. In this example the power receiving module 27 converts the received power into a 24 V DC current. The power receiving module 27 is further adapted to sense the type and magnitude of the electric power received from the external power supply 26, and to control the conversion of the power accordingly, so that the vehicle may be connected to a large variety of different power supplies, such as power grids of different local, national and/or international standards. The power receiving module may be connected with additional converters 22, 24, arranged to convert part or all of the received power into a more useful form.

In this example the control device 15 is also arranged to control the supply of energy from the storage pack to the load via the load control module 28 in the form of an inverter 28. However, the control of the load current may also be performed by another control device for controlling the operation of the load, or, in this case, the electric vehicle.

In FIG. 3 one example of a method according to the invention is shown. It should be appreciated that the steps in the method need not be carried out in the sequence described, but may be interchanged depending on the actual circumstances of use, for example depending on the choices of an operator. In this case the storage pack is arranged inside an electric vehicle, which is a preferred embodiment, but the method may also be used in relation to other kinds of appliances.

In a first step 41, the method comprises monitoring the energy levels in at least one subgroup of the storage cells in the storage pack. In this example, all cells in the storage pack are monitored, and further, each storage cell is monitored individually. The method also comprises monitoring the condition and state of the storage cells in the storage pack. The method further comprises generating an information message concerning the state, condition, and type of at least one storage cell in the storage pack. The subgroups of storage cells may for example be monitored by the feeding devices as previously described.

The monitoring of the condition, state, and energy levels is in this example continued throughout the use of the method, and is thus not limited to the first step 41 only. In the event that the energy level of at least one cell is low, and possibly in the event that the energy level of the storage pack as a whole is low, a message indicating the low energy is presented to an operator.

In a second step 42, the operator connects the control system for controlling the storage pack to an external power supply. The method then comprises receiving power from the external power supply, in this case from the power grid. The method further comprises sensing the current and/or voltage level of the external power supply, and adapting a receiving module to receive the sensed current and/or voltage level. Hence, the vehicle may be connected to many forms of different power supplies, which is advantageous since the vehicle may be moved between countries having different power grids.

In a third step 43, the method comprises initiating charging of the storage pack by supplying a small, joint charging current to at least a majority of the storage cells in the storage pack. In this example, the storage cells are connected in series, wherein the method comprises supplying the joint charging current to all cells by connecting to and feeding the current to the poles of the outermost cells in the pack. The initial charging may in some instances be necessary in order for sensors to sense the present energy levels in the cells. In other case the third step 43 may optionally be omitted.

In a fourth step 44, the method comprises increasing the joint charging current and/or voltage upon reception of information indicating that the energy levels in the cells are below a first threshold level. The first threshold level is in this example set to 20% below the maximum, safe energy level of each individual cell, wherein it is ensured that the cells are not overcharged. In another example the threshold level may be selected at a level from 20% to 5% below the maximum charge level of a storage cell or a subgroup of storage cells. The joint, charging current is increased to a suitable current for quick charging of the storage pack. By charging all cells in the pack together less resistance is experienced leading to a more efficient recharge.

In a fifth step 45, the method comprises receiving information that the energy level of at least one storage cell is above the first threshold level. The method then comprises withdrawing energy from the subgroups of storage cells comprising highly charged cells, wherein the joint recharge may continue for a longer time period. When the charge level continues to rise, the method then comprises reducing the joint charging current to the storage pack. Hence the charging rate is decreased, so that the probability of damaging a cell is reduced.

In a sixth step 46, the method comprises terminating the supply of the joint charging current to the storage pack upon reception of information that the energy level of at least one storage cell is above a second, higher threshold level. In this example the second, higher threshold level is set to 5% below the maximum safe energy level of each individual cell. Hence the joint charging of the pack is terminated as soon as one cell approaches its maximum energy level, wherein the risk of damages is reduced further. In another example the second threshold may be selected at a level from 15% to 3% below the maximum charge level of a storage cell or a subgroup of storage cells.

In a seventh step 47, the method comprises feeding a voltage and current in a separate voltage/current branch to a positive and a negative pole of at least one sub-group, in this example to a majority of the subgroups in the storage pack. The seventh step further comprises recharging the plurality of sub-groups of storage cells individually and independently by feeding said separate voltage and current to the positive and the negative pole of the at least one sub-group. In this example, each subgroup comprises only one storage cell, wherein each cell is individually charged. The individual charging of subgroups may be initiated after either or both of the reduction in step 45 or the termination in step 46 of the joint charging current.

In this example the separate voltage and current fed to each subgroup has an initial maximum magnitude corresponding to the joint, charging voltage divided onto each subgroup. Based on received information on the individual energy level for each cell, the magnitude of the individual, separate voltage is decreased until the storage cell is fully charged. The individual separate voltage may then be set equal with the voltage of the fully charged cell, wherein no charging and no withdrawing of energy from the cell take place. Alternatively, the feeding device may be switched off, so that there is no longer any connection between the positive and the negative poles of the cell. This may for example be performed by a control device, a feeding device, or a combination of the two.

In an eight step 48, when all, or nearly all, storage cells in the pack are fully charged the feeding of the individual, separate voltage and current to the cells is terminated. Alternatively, the individual, separate voltage and currents may be terminated by disconnection of the control system from the external power grid.

In a ninth step 49, the operator decides to drive the vehicle, wherein the method comprises supplying electric energy to one or more electric motors by each cell jointly supplying a joint storage pack voltage and current to the electric motors from the pack. Optionally, the method may also comprise controlling the power supply from the electrical energy storage pack to the electric motor.

In a tenth step 50, the method comprises sensing a lower charge level in at least one subgroup of storage cells The method also comprises sensing the average charge level for at least a majority of subgroups in the storage pack and comparing the sensed charge levels of the individual storage cells with the average charge level. The method then comprises withdrawing energy from at least one subgroup with a charge level higher than the average charge level. The method further comprises supplying energy by feeding a voltage and current in a separate voltage/current branch to at least one subgroup with a charge level lower than the average charge level, wherein the storage pack is balanced. The method also comprises avoiding feeding a subgroup of storage cells with an average energy level close to the average energy level of the storage pack. Thus subgroups with low energy levels are recharged, while subgroups with high energy levels are drained of charge, leading to a balancing of the energy levels in the storage cells in the storage pack. In this example the balancing is performed while operating the load, wherein the storage pack is continuously balanced throughout its use. In this example the subgroups are fed during operating conditions with less power consumption. When driving a vehicle there are periods in which there is no need to supply additional propulsion, such as when driving down a slope or similar. By balancing the storage pack during periods of low energy consumption there is less demands on the voltage/current branch for providing high energy outputs. By constantly balancing the storage pack during actual use of the vehicle the charge levels of the storage cells with lowest performance are continuously restored, wherein the total energy that can be supplied by the storage pack may be increased by a substantial amount.

In an eleventh step 51, in the event that the driver decelerates the vehicle, the method comprises that the electric motors are operated as generators instead of motors. The method thus comprises receiving regenerated power from the external load normally powered by the electrical energy storage pack. The method further comprises balancing the energy levels in the individual storage cells in the storage pack. The balancing may comprise recharging at least one sub-group of the storage cells in the storage pack, which sub-groups are in states of having the lowest energy levels among the sub-groups in the storage pack, by individually feeding a separate voltage and or/current to a positive and a negative pole of the at least one sub-groups with lowest energy levels. Hence the subgroups, in this example the individual storage cells, which have the lowest energy levels are recharged by the regenerated energy from deceleration of the vehicle. By feeding the subgroup separately, charging with a too high current, which might otherwise damage the subgroup, is also easily avoided.

In a twelfth step 52, the method comprises receiving information that the energy level in at least one sub-group of electrical energy storage cells, in this example of an individual storage cell, is below a third threshold level. The third threshold level is preferably set in the range of between 1%-15% of the energy level of a maximally charged cell. In this example the 0% level is thought to be the minimum level of charge before the cell take damage or for other reasons becomes operationally incapacitated.

The twelfth step 52, further comprises feeding a separate voltage in a separate voltage/current branch to a positive and a negative pole of at least one sub-group of connected storage cells in the storage pack. In this example the separate voltage has a magnitude corresponding to the supply voltage of the storage cell. By feeding the voltage to the positive and negative pole, from which poles electric energy normally is supplied from the cell, the supply of energy from the cell is prevented, so that energy no longer can be withdrawn from the cell. The energy is instead drawn from the feeding device supplying the voltage over the cell. Hence the cell with low energy is virtually disconnected from supplying energy to the external load, wherein the risk of damaging the cell is decreased while allowing the pack to continue operation.

The twelfth step 52 further comprises receiving the joint current from the storage pack, and returning part of the energy of the joint current to the feeding device and back to the storage cell. Hence the overall joint current supplied to the electric motors from the pack is decreased, since part of the joint current is returned to the pack. By feeding the separate voltage to the cell the cell also becomes recharged while driving the vehicle, so that the storage pack becomes balanced.

In a thirteenth step 53, the method comprises receiving information that the energy level in the electrical energy storage pack as a whole is below a fourth threshold level. The fourth threshold level may for example be within the range of 5-20% of the energy level of the fully charged storage pack. The method further comprises reducing the power supplied by the electrical energy storage pack based on the information

In a fourteenth step 54, the method comprises detecting that at least one subgroup or cell is in an error condition. The error condition may be very low energy, too low or too high temperature, or any other undesired condition a cell may be subjected to. The method further comprises generating an error message that at least a sub-group of the storage cells in the storage pack is in a condition of failure or close to failure upon detection of the condition. The method further comprises controlling the storage pack so as to reduce the maximum power supplied by the pack. Hence the driver of, for example, a vehicle may no longer drive at full speed and/or acceleration, but may still be able to drive to the edge of a road to avoid accidents.

The method also comprises detecting that there is a fatal error, either with a storage cell, and/or with the vehicle and/or electrical appliance. One example of a fatal error is if the vehicle has had an accident. The method further comprises generating an emergency signal and shutting down at least a majority of the storage cells in the storage pack in response to the signal. Preferably the method also comprises disconnecting subgroups or individual storage cells from each other. Hence the highest voltage in the vehicle is decreased considerably, to minimize the risk of personal damage due to electric shock.

In a fifteenth step 55, the operator decides to stop use of the vehicle or appliance, wherein the method comprises shutting down the power supply from the storage pack, which concludes the method.

The invention is not limited to the examples shown, but may be varied freely within the framework of the following claims. In particular, the different embodiments and examples shown may be freely mixed with each other, and similarly, it is not necessary that all features shown in a particular example are present in order for an embodiment to be within the scope of the invention. The invention is also useful in many applications in which a storage pack for storing energy is present, such as for machinery, tools, vehicles, buildings, etc.

1. A control system for controlling a storage pack (7), which storage pack comprises a plurality of storage cells (9) adapted to store energy and to supply the stored energy as electric energy jointly with at least a majority of the other storage cells in the storage pack as a joint, storage pack voltage and current, characterized in that the control system comprises a plurality of feeding devices (17), each feeding device being adapted to be electrically connected with a subgroup (10a-d) of at least one storage cell(s) in the storage pack, and at least one supply module (37) arranged to electrically interconnect the plurality of feeding devices, wherein each of at least a majority of the feeding devices is adapted to handle an exchange of energy between its subgroup of storage cell(s) and the supply module.

2. A control system according to claim 1, characterized in that each of at least a majority of the feeding devices (17) is arranged to handle the exchange of energy independently from the other feeding devices connected with the supply module, and in that the control system comprises a control device (15) arranged to individually and independently control each of the feeding devices and the handling of the exchange of energy.

3. A control system according to claim 2, characterized in that the control device (15) is arranged to receive information on the present charge levels of the subgroups of storage cells, and to control at least one feeding device connected with a subgroup with higher charge level than an average charge level of the storage pack to transfer energy from its subgroup of storage cells to the supply module.

4. A control system according to claim 3, characterized in that the control device (15) is arranged to control the at least one feeding device to transfer the energy to the supply module during recharge of the storage pack with a joint recharge voltage and current.

5. A control system according to any of the claims 1-4, characterized in that the supply module comprises a first (2) and second (4) power lines connected with and electrically interconnecting at least a majority of the plurality of feeding devices.

6. A control system according to claim 5, characterized in that the supply module comprises a capacitor (38) connected between the power lines.

7. A control system according to any of the claims 1-6, characterized in that at least a majority of the feeding devices (17) each comprises a converter (23) comprising a first terminal having two contacts adapted to be connected with a negative and a positive pole of the subgroup of storage cells, respectively.

8. A control system according to one of claim 5 or 6, and claim 7, characterized in that the converter (23) comprises a second terminal having two contacts connected with the first and second power lines, respectively, wherein the converter is arranged to convert a common feeding voltage into a separate feeding voltage for its subgroup of cells and vice versa.

9. A control system according to claim 7 or 8, characterized in that the converter is a DC/DC-converter.

10. A control system according to any of the claims 1-9, characterized in that the supply module (37) is arranged to supply a common feeding voltage to the plurality of feeding devices, and that the supply module comprises a voltage controller (36) arranged for striving to keep the common feeding voltage at a target voltage.

11. A feeding device connectable with a storage pack comprising a plurality of storage cells (9) adapted to store energy and to supply the stored energy as electric energy, characterized in that the feeding device (17) is adapted to be electrically connected with a subgroup (10) of at least one storage cell(s) in the storage pack, and to be electrically connected with a supply module (37), which supply module is adapted to be further connected with a plurality of similar feeding devices in order to electrically interconnect the feeding devices, wherein the feeding device (17) is adapted to handle an exchange of energy between its subgroup of storage cell(s) and the supply module.

12. A feeding device according to claim 11, characterized in that the feeding device (17) is arranged to handle the exchange of energy independently from any other feeding devices connected with the supply module.

13. A feeding device according to claim 11 or 12, characterized in that the feeding device (17) is adapted to estimate the present charge level of the subgroup of storage cell(s), and to transfer energy from the subgroup to the supply module (37) when obtaining information that the present charge level for its subgroup of storage cell(s) is higher than an average charge level of the storage pack.

14. A feeding device according to any of the claims 11-13, characterized in that the feeding device (17) is adapted to be connected with a first (2) and second (4) power lines belonging to the supply module and interconnecting a plurality of similar feeding devices.

15. A feeding device according to any of the claims 11-14, characterized in that the feeding device comprises a converter (23) comprising a first terminal having first and second contacts adapted to be connected with a negative and a positive pole of the subgroup of storage cells, respectively.

16. A feeding device according to claim 14 and 15, characterized in that the converter (23) comprises a second terminal having a first and a second contacts connected with the first and second power lines, respectively, wherein the converter is arranged to convert a common feeding voltage provided by the power lines into a separate feeding voltage for the subgroup of storage cells, and vice versa.

17. A feeding device according to claim 15 or 16, characterized in that the feeding device comprises a DC/DC-converter.

18. A feeding device according to any of the claims 11-17, characterized in that the feeding device (17) is adapted to receive a common feeding voltage from the supply module having a constant target voltage.

19. A subgroup comprising at least one storage cell adapted to store energy and to supply the stored energy as electric energy, characterized in that the subgroup comprises a feeding device (17) according to any of the claims 11-18 connected with the subgroup.

20. A supply module for aiding in controlling a storage pack (7) comprising a plurality of storage cells (9) adapted to store energy and to supply the energy as electric energy, characterized in that the supply module (37) is adapted to be electrically connected with and to electrically interconnect a plurality of feeding devices (17), each feeding device being adapted to be electrically connected with a subgroup of storage cells in the storage pack, wherein the supply module is further adapted to allow the feeding devices (17) to handle an exchange of energy between the supply module and their respective subgroups of storage cells.

21. A supply module according to claim 20, characterized in that the supply module (37) is adapted to allow each of at least a majority of the feeding devices to handle an exchange of energy between the supply module and an individual subgroup (10) of storage cells independently from the other feeding devices.

22. A supply module according to any of the claim 20 or 21, characterized in that the supply module (37) is adapted to allow a transfer of energy between any one feeding device (17) and any other of the feeding devices connected with the supply module.

23. A supply module according to any of the claims 20-22, characterized in that the supply module (37) comprises a first (2) and a second (4) power lines connected with each of at least a majority of the plurality of feeding devices for electrically interconnecting the feeding devices.

24. A supply module according to claim 23, characterized in that the supply module comprises a capacitor (38) connected between the power lines.

25. A supply module according to claim 23 or 24, characterized in that the supply module comprises a voltage controller (36) arranged for striving to keep a common feeding voltage between the power lines at a target voltage.

26. A supply module according to one of the claims 23-25, characterized in that the supply module (37) is adapted to be connected with a plurality of feeding devices, each comprising a converter (23) comprising a terminal having a first and a second contacts, wherein the first (2) and second (4) power lines are adapted to be connected with the first and second contacts, respectively.

27. A control device for controlling a storage pack (7) comprising a plurality of storage cells (9) adapted to store energy and to supply the stored energy as electric energy, characterized in that the control device (15) is adapted for controlling a plurality of feeding devices (17) connected with subgroups of at least one storage cell(s) in the storage pack, and to control the feeding devices to handle an exchange of energy between their individual subgroups of storage cells and a supply module (37) arranged to electrically interconnect the feeding devices.

28. A control device according to claim 27, characterized in that the control device (15) is adapted to individually and/or independently control each of at least a majority of the feeding devices (17), and the handling of the exchange of energy between the supply module and their individual subgroups of storage cells.

29. A control device according to claim 27 or 28, characterized in that the control device (15) is arranged to receive information on the present charge levels of the subgroups of storage cells, and to control at least one feeding device (17) connected with a subgroup with higher charge level than an average charge level of the storage pack to transfer energy from that subgroup to the supply module (37).

30. A control device according to claim 29, characterized in that the control device (15) is arranged to control the at least one feeding device (17) to transfer energy to the supply module during a recharge of the storage pack with a joint recharge voltage and current.

31. A control device according to any of the claims 27-30, characterized in that the control device (15) is adapted to transmit control signals to at least a majority of the feeding devices for controlling a controllable converter (23) comprised within each of the feeding devices.

32. A control device according to any of the claims 27-31, characterized in that the control device (15) is able to control any two feeding devices (17) connected with the supply module to transfer energy in between them via the supply module (37).

33. A method for controlling a storage pack comprising a plurality of storage cells adapted to store energy and to supply the stored energy as electric energy, characterized in that the method comprises
exchanging energy between a supply module and at least one subgroup of storage cells in the storage pack with a feeding device, which feeding device is electrically connected between the subgroup of storage cells and the supply module, and which supply module electrically interconnects a plurality of such feeding devices.

34. A method according to claim 33, characterized in that the method comprises
individually and/or independently controlling each of at least a majority of a plurality of feeding devices to individually and/or independently handle the exchange of energy between its subgroup of storage cells and the supply module.

35. A method according to any of the claims 33-34, characterized in that the method comprises
receiving information on the present charge levels of the subgroups of storage cells, and
controlling at least one feeding device connected with a subgroup with higher charge level than an average charge level of the storage pack to transfer energy from that subgroup to the supply module.

36. A method according to claims 35, characterized in that the method comprises
recharging the storage pack with a joint recharge voltage and current, and
controlling the at least one feeding device to transfer energy from that subgroup to the supply module during the recharge of the storage pack.

37. A method according to any of the claims 33-36, characterized in that the method comprises
providing a first and a second power line in the supply module, which are connected with the feeding devices for supplying the common feeding voltage to the feeding devices, and
striving to keep the common feeding voltage at a target voltage.

38. A method according to any of the claims 33-37, characterized in that the method comprises
transferring energy from any one feeding device to any other feeding device via the supply module.

39. An electric vehicle or vessel, characterized in that the vehicle or vessel comprises a control system according to any of the claims 1-10.
